(19) United States
(12) Patent Application Publication
(10) Pub. No.: US 2006/0050227 A1
(43) Pub. Date: Mar. 9, 2006

(54) Prescription adapter ring and eyewear incorporating same

(75) Inventors: Ernest R Fernandez, SAN JOSE, CA (US); Aaron M Markovitz, Denver, CO (US)

Correspondence Address: Steven B Pokotilow;Stroock & Stroock & Lavan, 180 Maiden Lane, New York, NY, 10038, US

(73) Assignee: PAN OPTX, INC., PLEASANTON, CA (US)

(21) Appl. No.: 10/529,991

(22) PCT Filed: Sep. 30, 2003
(86) PCT No.: PCT/US03/31151

§ 371 Date: Mar. 31, 2005

Related U.S. Application Data
(60) Provisional application No. 60/415,609, filed on Oct. 1, 2002.

(51) Int. Cl. G02C 5/00

(52) U.S. Cl. 351/154

(57) ABSTRACT

A prescription adapter ring for use in eyewear, and in particular, a prescription adapter ring for use in wrap-type eyewear.

### CROSS REFERENCE TO RELATED APPLICATIONS

The present application claims the benefit of U.S. Provisional Patent Application Ser. No. 60/415,609, filed on Oct. 1, 2002, which is incorporated herein by reference in its entirety.

### FIELD OF THE INVENTION

The present invention relates to prescription eyewear, and in particular, relates to a prescription lens adapter ring for use with wrap-type eyewear.

### BACKGROUND OF THE INVENTION

Standard wrap-type eyewear is designed to fit closely to the face. The actual lens used in the typical wrap-type eyewear must also be “wrapped”, i.e., have a relatively large curvature. This works fine for normal, non-prescription type lenses. This also generally works fine for prescription lenses in the plus or minus three power range. However, because of the optics involved, it is generally not possible to make a prescription lens having a large curvature for prescriptions in a higher power range. Thus, no one has been able to offer a prescription lens in wrap-type eyewear for prescriptions in a generally higher power range. The present invention is directed towards overcoming disadvantages of the prior art by providing a prescription adapter ring for use with higher power prescription lens.

### SUMMARY OF THE INVENTION

The present invention relates to a prescription adapter ring for use in eyewear, and in particular, a prescription adapter ring for use in wrap-type eyewear. The adapter ring is designed to fit into the channel or groove where a typical lens is normally installed. The inner surface of the adapter ring has a groove or channel to accept a prescription lens therein. Thus, the prescription adapter ring permits Panoptx, Inc., the assignee of the present invention, to offer a high wrap prescription sunglass product. Because the ring is constructed so as to fit in the groove normally housing a lens, the prescription adapter ring of the present invention can also be used to retrofit existing eyewear.

Other objects and features of the present invention will become apparent from the following detailed description, considered in conjunction with the accompanying drawing figures. It is to be understood, however, that the drawings are designed solely for the purpose of illustration and not as a definition of the limits of the invention, for which reference should be made to the appended claims.

### BRIEF DESCRIPTION OF THE DRAWINGS

In the drawing figures, which are not to scale, and which are merely illustrative, and wherein like reference characters denote similar elements throughout the several views:

FIG. 1 is a perspective view of eyewear having two removable prescription adapter rings mounted thereon;

FIG. 2 is an exploded perspective view of the eyewear of FIG. 1 with one of the prescription adapter rings separated from the eyewear;

FIG. 3 is a top partial cross sectional view of the eyewear of FIG. 1;

FIG. 4 is a cross sectional view taken along the 4-4 line depicted in FIG. 1;

FIG. 5 is an enlarged view of the circled area depicted in FIG. 3;

FIG. 6 is a perspective view of eyewear having two removable prescription adapter rings mounted thereon, with the eyewear also having a removable eyecup installed on the rear side thereof;

FIG. 7 is an exploded perspective view of the eyewear of FIG. 6 with one of the prescription adapter rings separated from the eyewear;

FIG. 8 is a top partial cross sectional view of the eyewear of FIG. 6;

FIG. 9 is a cross sectional view taken along the 9-9 line depicted in FIG. 6;

FIG. 10 is an enlarged view of the circled area depicted in FIG. 8.

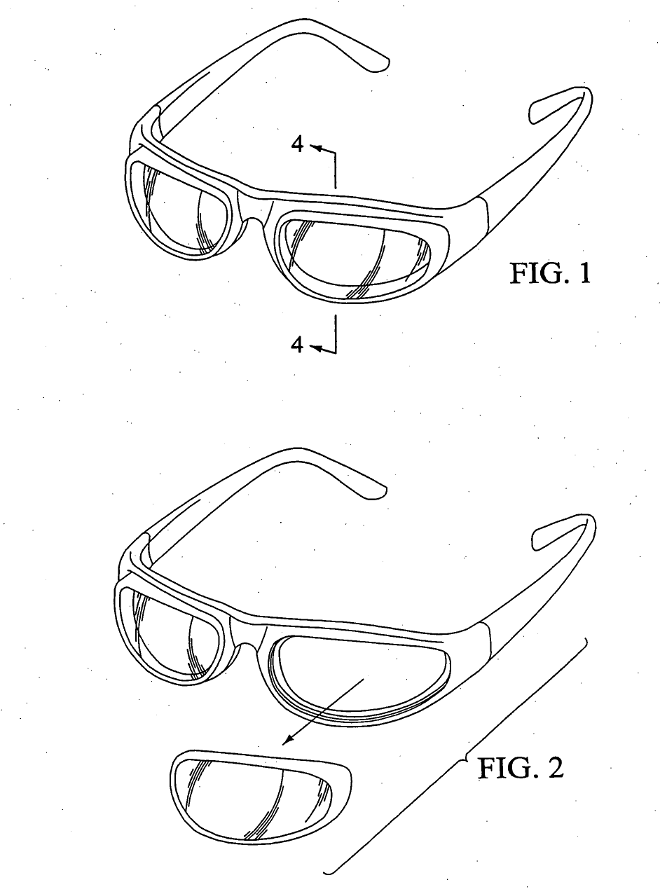

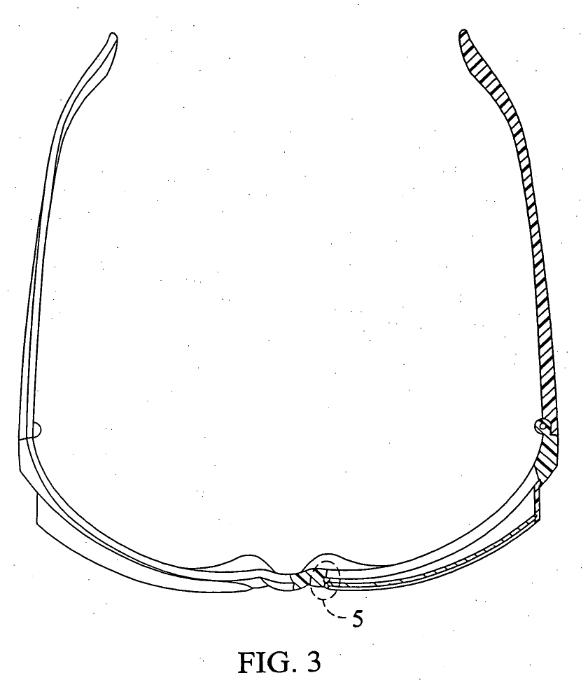

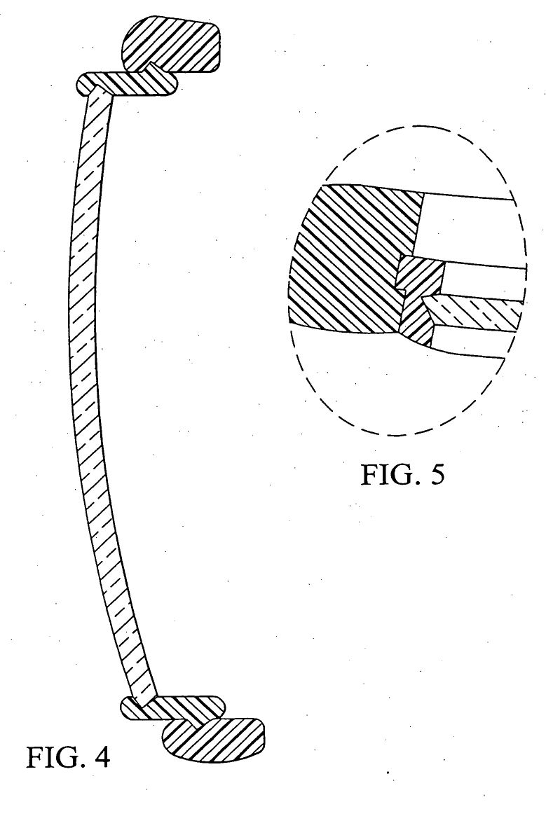

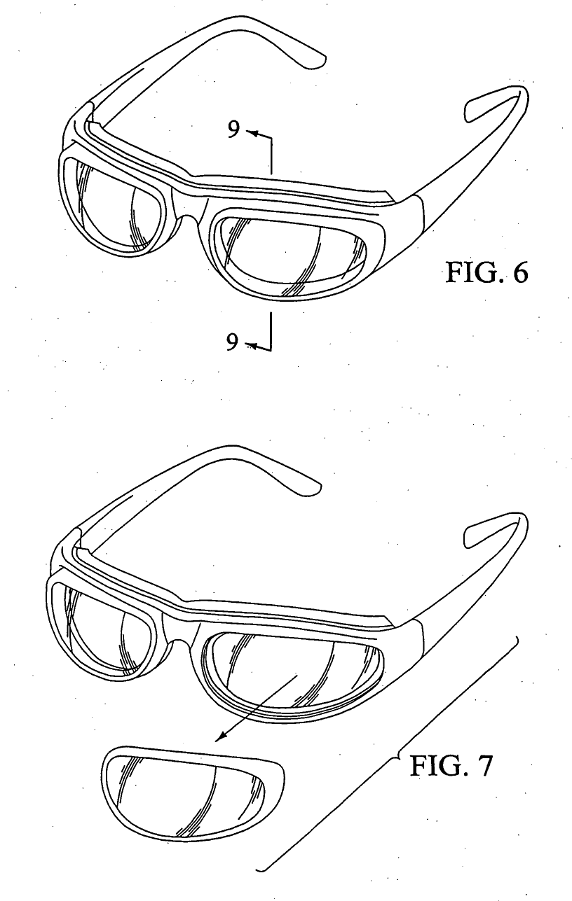

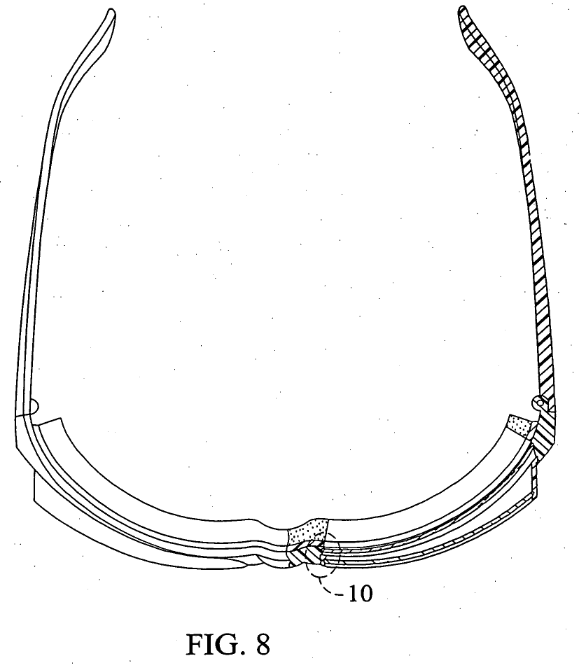

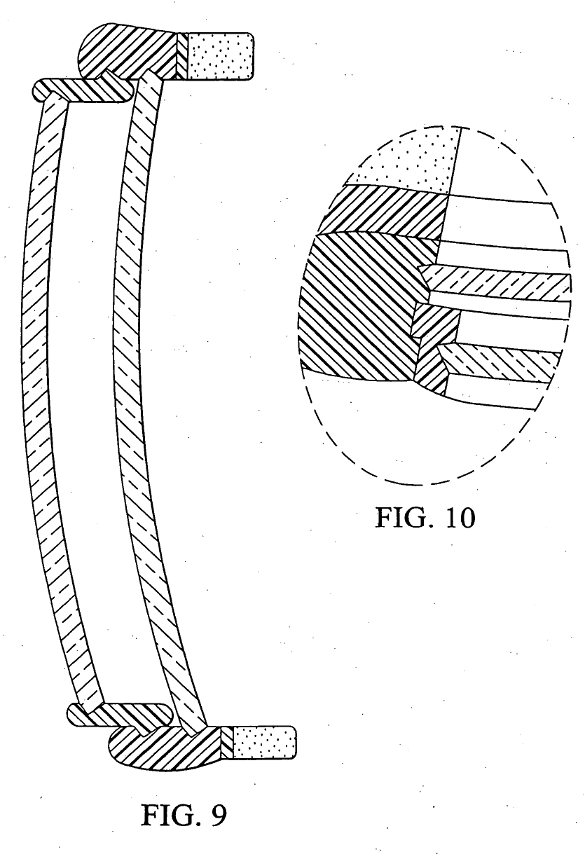

### DETAILED DESCRIPTION OF THE PRESENTLY PREFERRED EMBODIMENTS

The present invention relates to a prescription adapter ring for use in eyewear, and in particular, a prescription adapter ring for use in wrap-type eyewear. In general terms, the adapter ring is designed and constructed so as to mount or otherwise be affixed to the frame of wrap-type eyewear and is also designed and constructed so as to maintain a prescription lens therein.

In one aspect of the present invention, the adapter ring is designed so that the rear surface or edge fits into a channel where a typical lens would be installed. Such a construction allows the adapter ring of the present invention to be used to retrofit existing eyewear. The front inner surface of the ring has a groove or channel to accept a prescription lens therein. Of course other methods of mounting the ring to the eyewear and for mounting a prescription lens therein are also envisioned. For example, although FIGS. 5 and 10 depict a square-shaped groove for maintaining the adapter ring, other shaped and sized mounting means are contemplated without departing from the spirit of the invention. The particular shape and size of the means for mounting the ring is a matter of application specific design choice.

In any event, as seen in the Figures, the rear portion of the adapter ring generally matches the wrap of the eyewear frame, while the front portion of the ring where the prescription lens is installed has less of a wrap. Thus, a higher power prescription lens can be mounted or otherwise installed in the adapter ring, thereby providing wrap-type prescription eyewear, even for high power prescriptions. Thus, the prescription adapter ring permits Panoptx, Inc. to offer a high wrap prescription sunglass product.

The adapter ring of the present invention can be either fixed or removable from the eyewear. Further, the lens within the adapter ring can be either fixed or removable. Designed as such, a user will be able to readily switch lenses which will greatly increase the range and functionality of the eyewear. The adaptability of the present invention is further enhanced by incorporating an eyecup to the eyewear, which itself can be either fixed or removable and which may also incorporate a removable lens therein.

The sunglass frame can be any standard wrap-type frame with the typical lens removed. With regard to the eyecup, it can be removable or fixed, and may also have an additional lens installed therein, as described more fully in co-pending application Ser. No. 60/415,483, which is hereby incorporated by reference.

In a preferred embodiment, the eyewear of the present invention also includes a ventilation means, such as for example, one or more ventilating apertures either incorporated as part of the ring itself or incorporated as part of the frame and/or eyecup.

In a preferred embodiment, the adapter ring is formed of an opaque, clear or translucent material. Formed as such, the adapter ring can serve as a side lens to provide enhanced peripheral vision and permit greater ambient light to reach the eyes of the wearer. Such a construction will aid in preventing and/or diminishing tunnel vision.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between. In particular, this invention should not be construed as being limited to the dimensions, proportions or arrangements disclosed herein.

What is claimed is:

1. A prescription adapter ring for mounting a prescription lens in wrap-type eyewear, said adapter ring being mountable to the eyewear and comprising:
a rear portion having a first curvature that generally matches the curvature of the wrap type eyewear, said rear portion comprising a mounting means for maintaining said adapter ring to said eyewear; and
a front portion comprising a lens mounting means for mounting a prescription lens onto the adapter ring, said lens mounting means having a second curvature that is less than said first curvature.

2. The adapter ring of claim 1, wherein the lens mounting means comprises a groove to receive the edge of the prescription lens.

3. The adapter ring of claim 1, wherein the ring mounting means comprises one or more insertion portions to fit into one or more grooves in the frame.

4. The adapter ring of claim 1, wherein the ring mounting means is positioned between the lens and the frame.

5. The adapter ring of claim 1, further comprising an eyecup.

6. The adapter ring of claim 1, wherein the adapter ring is translucent.

7. The adapter ring of claim 1, further comprising one or more ventilating apertures.

8. The adapter ring of claim 1, wherein the lens is fixedly onto the adapter ring.

9. The adapter ring of claim 1, wherein the lens is removably attached to the adapter ring.

10. The adapter ring of claim 1, wherein the adapter ring is fixedly attached to the frame.

11. The adapter ring of claim 1, wherein the adapter ring is removably attached to the frame.

12. High-wrap prescription sunglasses comprising:
a high-wrap frame having a high-wrap lens mounting means therein;
a prescription adapter ring removably mounted in said high-wrap lens mounting means, said adapter ring comprising a prescription lens therein.

13. The sunglasses of claim 12, wherein said mounting means has a higher wrap than said prescription lens.
